(19) United States
(12) Patent Application Publication
(10) Pub. No.: US 2018/0132308 A1
(43) Pub. Date: May 10, 2018

(54) WIRELESS NETWORK CONSTRUCTION APPARATUS, WIRELESS NETWORK CONSTRUCTION METHOD, AND COMPUTER-READABLE STORAGE MEDIUM

(71) Applicant: NEC Solution Innovators, Ltd., Koto-ku, Tokyo (JP)

(72) Inventor: Tohru MIYAZAKI, Tokyo (JP)

(73) Assignee: NEC Solution Innovators, Ltd., Koto-ku, Tokyo (JP)

(21) Appl. No.: 15/561,113

(22) PCT Filed: Mar. 29, 2016
(86) PCT No.: PCT/JP2016/060064

§ 371 Date: Sep. 25, 2017

(30) Foreign Application Priority Data
Mar. 30, 2015 (JP) 2015-070079

(51) Int. Cl. H04W 84/18; H04W 72/12; H04W 76/15; H04W 76/14

(52) U.S. Cl. CPC H04W 84/18; H04W 72/121; H04W 84/12; H04W 76/14; H04W 76/15

(57) ABSTRACT

Provided is a wireless network construction apparatus capable of constructing a network according to which wireless communication terminals can efficiently and safely communicate. A wireless network construction apparatus is provided in a wireless communication terminal and constructs a wireless network with another wireless communication terminal. The wireless network construction apparatus includes a wireless communication unit that performs wireless communication with the other wireless communication terminal, a voting unit that, in a case where the wireless communication terminal is participating in construction of the wireless network, votes for a wireless communication terminal for which participation in the construction of the wireless network is requested, via the wireless communication unit, and a network construction unit that participates in the construction of the wireless network based on the voting result in the case where the wireless communication terminal is the wireless communication terminal that was voted for by the voting unit.

### TECHNICAL FIELD

The present invention relates to a wireless network construction apparatus for constructing a wireless network between terminals, a wireless network construction method, and a computer-readable storage medium storing a program for realizing them.

### BACKGROUND ART

In recent years, research for using a mobile ad-hoc network to communicate in a state in which a base network cannot be used due to a disaster or power outage has been actively performed. As disclosed in Patent Document 1 for example, the mobile ad-hoc network enables mutual communication due to wireless communication terminals being connected in a network. Accordingly, it is possible to perform communication without using a base station or the like.

With an ad-hoc network communication system disclosed in Patent Document 1, if another communication terminal that has given a join request to a management integration terminal that manages a communication group satisfies a condition for joining the communication group, the said another communication terminal is permitted to join by the management integration terminal. As disclosed in Patent Document 2 for example, a method in which a user approves registration of a requesting device requesting registration in a wireless ad-hoc network is also known as a method of requesting permission to participate in a network.

### CITATION LIST

### Patent Document

Patent Document 1: JP 2009-165070A

Patent Document 2: JP 2007-523551A

### DISCLOSURE OF THE INVENTION

### Problems to be Solved by the Invention

With the above-described mobile ad-hoc network, in general, the users need to set the communication mode of the wireless communication terminals in order for the wireless communication terminals to perform communication. However, when a disaster or the like occurs, there is a possibility that a situation in which a user cannot operate a wireless communication terminal will occur due to loss of the wireless communication terminal or an unforeseen accident caused by the user.

Also, with a mobile ad-hoc network, it is important to provide redundancy by using as many wireless communication terminals as possible as communication routes. However, in a situation in which a wireless communication terminal for which the communication mode cannot be set as described above exists, the network constructed by the wireless communication terminals is limited, and the mobile ad-hoc network does not function sufficiently in some cases.

Accordingly, as with the configuration disclosed in the above-described Patent Documents 1 and 2, a method is conceivable in which, in a case where a wireless communication terminal that cannot participate in a network as described above exists, the wireless communication terminal is mandatorily caused to participate in the ad-hoc network by giving another user administrative authority. However, if the user is thus given administrative authority, there is a possibility that a wireless communication terminal will be taken over or the like if the administrative authority is misused, and there is a possibility of developing a security weakness.

An object of the present invention is to provide a wireless network construction apparatus capable of constructing a network according to which wireless communication terminals can efficiently and safely communicate.

### Means for Solving the Problems

In order to achieve the above-described object, a wireless network construction apparatus according to an aspect of the present invention is a wireless network construction apparatus that is provided in a wireless communication terminal, and is for constructing a wireless network with other wireless communication terminal. The wireless network construction apparatus includes: a wireless communication unit configured to perform wireless communication with the other wireless communication terminal; a voting unit configured to, in a case where the wireless communication terminal is participating in construction of the wireless network, transmit vote data via the wireless communication unit to a wireless communication terminal for which participation in the construction of the wireless network has been requested; and a network construction unit configured to participate in the construction of the wireless network according to the result of voting in a case where the wireless communication terminal is a wireless communication terminal that was voted for by a said voting unit.

In order to achieve the above-described object, a wireless network construction method according to an aspect of the present invention is a wireless network construction method for constructing a wireless network with a plurality of wireless communication terminals. The wireless network construction method includes: a participation state detection step of detecting states of participation in the wireless network of the plurality of wireless communication terminals; a voting step of transmitting vote data for prompting participation in the wireless network via wireless communication from a wireless communication terminal participating in the construction of the wireless network to a wireless communication terminal selected by a user of a wireless communication terminal participating in the construction of the wireless network, from among wireless communication terminals not participating in the construction of the wireless network; and a network construction step in which the wireless communication terminal that was voted for participates in the construction of the wireless network according to the result of voting.

Furthermore, in order to achieve the above-described object, a computer-readable storage medium according to an aspect of the present invention is a program for causing execution of a wireless network construction method for constructing a wireless network with a plurality of wireless communication terminals. The program stores a program that includes commands for causing a computer to execute: a participation state detection step of detecting states of participation in the wireless network of the plurality of wireless communication terminals; a voting step of transmitting vote data for prompting participation in the wireless network via wireless communication from a wireless communication terminal participating in the construction of the wireless network to a wireless communication terminal selected by a user of a wireless communication terminal participating in the construction of the wireless network from among wireless communication terminals not participating in the construction of the wireless network; and a network construction step in which the wireless communication terminal that was voted for participates in the construction of the wireless network according to the result of voting.

### Effects of the Invention

As described above, according to the configuration of the present invention, it is possible to provide a wireless network construction apparatus capable of constructing a wireless network according to which wireless communication terminals can efficiently and safely communicate.

### BRIEF DESCRIPTION OF THE DRAWINGS

FIG. 1 is a block diagram showing an overall configuration of a wireless network construction apparatus.

FIG. 2 is a diagram schematically showing construction of a wireless network.

FIG. 3 is a block diagram showing a detailed configuration of a wireless network construction apparatus.

FIG. 4 is a flow showing an example of operations performed by the wireless network construction apparatus.

FIG. 5 is a diagram showing an example of a configuration of a computer.

### DESCRIPTION OF EMBODIMENT

### Embodiment

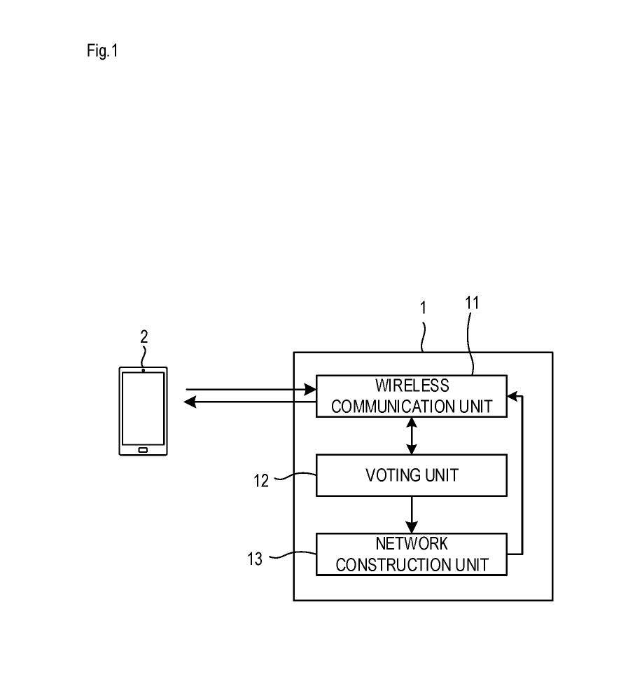

Hereinafter, a wireless network construction apparatus, a wireless network construction method, and a program according to an embodiment of the present invention will be described with reference to FIGS. 1 to 5.

FIG. 1 is a diagram showing an overall configuration of a wireless network construction apparatus 1 according to an embodiment of the present invention. The wireless network construction apparatus 1 is provided in a wireless communication terminal. The wireless network construction apparatus 1 is an apparatus that constructs a wireless network with a wireless network construction apparatus of another wireless communication terminal 2, and among wireless communication terminals not participating in the construction of the network, allows participation of a wireless communication terminal that the user wants to allow to participate in the construction of the network according to a result of voting performed along with the wireless network construction apparatuses of other wireless communication terminals.

The wireless network construction apparatus 1 constructs a wireless network with another wireless communication terminal using wireless communication. An ad-hoc network is an example of this kind of wireless network. With an ad-hoc network, mutual communication is made possible due to wireless communication terminals being connected in a network, and communication can be performed without using a base station or the like.

Here, wireless communication is communication that is performed using radio waves, such as WiFi, a wireless LAN, or Bluetooth (registered trademark).

The wireless network construction apparatus 1 detects a wireless communication terminal not participating in the construction of the wireless network, and in order to allow the wireless communication terminal to participate in the construction of the wireless network, the wireless network construction apparatus 1 votes on whether or not to allow the wireless communication terminal not participating in the construction of the wireless network to participate, together with the wireless network construction apparatus of another wireless communication terminal participating in the wireless network. Then, according to the voting result, the wireless network construction apparatus of the wireless communication terminal not participating in the wireless network determines whether or not to participate in the construction of the wireless network. If the wireless network construction apparatus 1 of that wireless communication terminal determines that the wireless communication terminal is to participate in the construction of the wireless network, the wireless network construction apparatus 1 of the wireless communication terminal performs construction of the wireless network along with the other wireless communication terminals.

Specifically, the wireless network construction apparatus 1 includes a wireless communication unit 11, a voting unit 12, and a network construction unit 13. The wireless communication unit 11 performs wireless communication with another wireless communication terminal 2. Specifically, the wireless communication unit 11 constructs the wireless network with the other wireless communication terminal 2 and performs transmission and reception of later-described vote data and addition data at a time of voting for a wireless communication terminal not participating in the construction of the wireless network.

The voting unit 12 votes for a wireless communication terminal not participating in the construction of the wireless network. Specifically, the voting unit 12 detects the states of participation in the construction of the wireless network of other wireless communication terminals and displays the result as a list. Then, if the user selects a wireless communication terminal that he or she wants to allow to participate in the construction of the wireless network, the voting unit 12 casts a vote requesting participation for the wireless communication terminal.

If the number of votes requesting participation in the construction of the wireless network from other users is greater than a threshold value as a result of the voting performed by the voting unit 12, the network construction unit 13 performs construction of the network with the other wireless communication terminal.

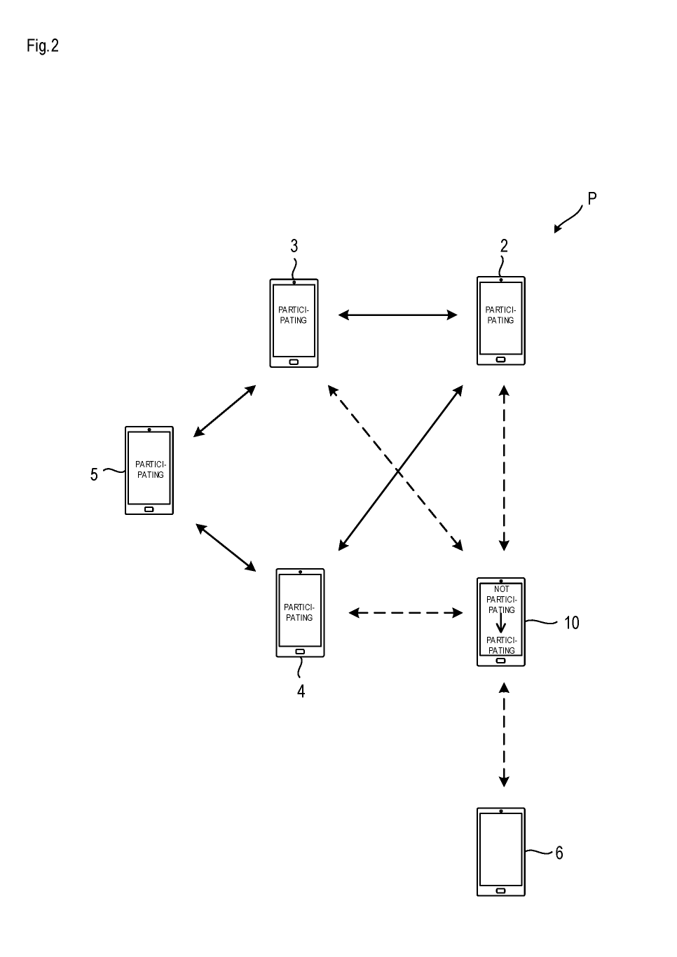

FIG. 2 is a diagram schematically showing the wireless communication terminal 10 constructing a network due to the voting of the other wireless communication terminals 2 to 5. As shown in FIG. 2, a wireless network has been constructed by the wireless communication terminals 2 to 5 (a network in which mutual wireless communication is possible has been constructed as indicated by the solid lines). In the state shown in FIG. 2, the wireless communication terminals 2 to 5 are located far away from the wireless communication terminal 6, and therefore have difficulty performing direct wireless communication with the wireless communication terminal. 6, even though they need to perform transmission and reception of information with the wireless communication terminal 6 via a wireless network. Note that a wireless network construction apparatus 1 is provided in each of the wireless communication terminals 2 to 6, and 10.

In this state, the wireless communication terminals 2 to 5 can perform transmission and reception of information with the wireless communication terminal 6 via the wireless communication terminal 10 due to the wireless communication terminal 10 participating in the construction of the wireless network. In this case, the users of the wireless communication terminals 2 to 5 use their wireless network construction apparatuses 1 to vote on the wireless communication terminal 10 that is not participating in the construction of the wireless network and whether or not to allow the wireless communication terminal 10 to participate in the construction of the wireless network. As a result of the voting, if the number of votes for allowing the wireless communication terminal 10 to participate in the construction of the wireless network is greater than a threshold value, the wireless communication terminal 10 participates in the construction of the wireless network. Accordingly, the wireless network indicated by the solid lines and broken lines in FIG. 2 is constructed.

With the above-described configuration, even if the user cannot operate the wireless communication terminal 10 due to loss of the wireless communication terminal 10 or an unintentional accident, the wireless communication terminal 10, which is needed in the construction of the wireless network, can be allowed to participate in the construction of the wireless network based on the consensus of the other users.

Accordingly, a network for wireless communication can be constructed using the multiple wireless communication terminals 2 to 6 and 10 without giving a specific user authority over the wireless network or the like. Accordingly, it is possible to construct a wireless network for performing wireless communication efficiently and safely.

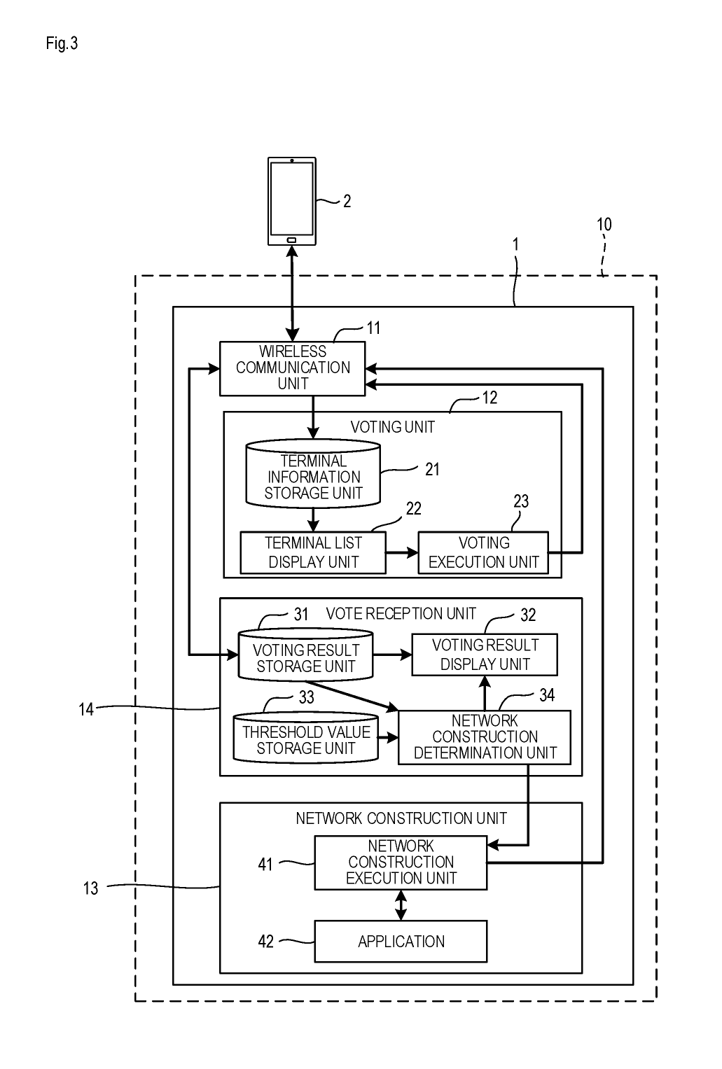

Next, a specific configuration of the wireless network construction apparatus 1 will be described in detail with reference to FIG. 3. FIG. 3 is a block diagram showing a specific configuration of the wireless network construction apparatus 1 according to an embodiment of the present invention.

The wireless network construction apparatus 1 is constituted by a CPU, a memory, and the like in the wireless communication terminal 10, for example. The wireless network construction apparatus 1 includes the wireless communication unit 11, the voting unit 12, the network construction unit 13, and a vote reception unit 14.

The wireless communication unit 11 performs wireless communication with the other wireless communication terminal 2. Specifically, the wireless communication unit 11 constructs the wireless network with the other wireless communication terminal 2 and receives the ID of that terminal and information on whether or not the terminal is participating in the construction of the wireless network from the other wireless communication terminal. 2. Also, the wireless communication unit 11 transmits and receives vote data and addition result data with the other wireless communication terminal 2 using the voting unit 12 and the vote reception unit 14 at the time of a later-described voting operation.

If a wireless communication terminal not participating in the construction of the wireless network exists, the voting unit 12 performs an operation of voting on whether or not to allow the wireless communication terminal to participate. The voting unit 12 includes a terminal information storage unit 21, a terminal list display unit 22, and a voting execution unit 23.

The terminal information storage unit 21 stores the ID of the other wireless communication terminal 2 and the information on whether or not the other wireless communication terminal 2 is participating in the construction of the wireless network, which were received by the wireless communication unit 11. The terminal information storage unit 21 stores the ID and the information on whether or not the other wireless communication terminal 2 is participating in the construction of the wireless network in association with each other.

A terminal list display unit 22 displays, as a list, the IDs of the wireless communication terminals and the information on whether or not they are participating in the construction of the wireless network, which are stored in the terminal information storage unit 21. For example, the terminal list display unit 22 displays the IDs and the information as a list on a liquid crystal display or the like. Also, the terminal list display unit 22 displays a selection button (not shown) on a display screen such that the user can perform voting by selecting the wireless communication terminal that he or she wants to allow to participate in the wireless network.

The voting execution unit 23 performs the operation of voting for the wireless communication terminal that the user wants to allow to participate in the construction of the wireless network in the case where the user selects that wireless communication terminal in the list of IDs and information of the wireless communication terminals displayed on the screen by the terminal list display unit 22. Specifically, the voting execution unit 23 transmits the vote data via the wireless communication unit 11 to the wireless communication terminal that the user wants to allow to participate in the construction of the wireless network. The vote data also includes the ID of the wireless communication terminal that performed voting. Note that the voting execution unit 23 transmits the vote data using the ID of the wireless communication terminal that was voted for (the wireless communication terminal that the user wants to allow to participate in the construction of the wireless network).

With the above-described configuration, a wireless communication terminal that is not participating in the construction of the wireless network is detected, and voting can be performed so as to allow the wireless communication terminal to participate in the construction of the wireless network.

The vote reception unit 14 includes a voting result storage unit 31, a voting result display unit 32, a threshold value storage unit 33, and a network construction determination unit 34. The voting result storage unit 31 stores the voting result in the wireless communication terminal that is being voted on in the case where voting is performed by the other wireless communication terminals participating in the construction of the wireless network. That is, the voting result storage unit 31 adds up and stores the vote data in the case where the vote data is transmitted via the wireless communication unit 11 from the other wireless communication terminals participating in the construction of the wireless network. Note that the voting result storage unit 31 stores not only the addition result of the vote data, but also the IDs of the wireless communication terminals from which the vote data was transmitted.

The voting result storage unit 31 is configured to transmit the addition result of the vote data to the other wireless communication terminal 2 via the wireless communication unit 11. Accordingly, it is possible to transmit the voting result to not only the wireless communication terminal being voted on, but also to the other wireless communication terminals. Accordingly, convenience to the users can be improved since it is possible to keep track of the voting result using the wireless communication terminals constructing the wireless network. Note that in the present embodiment, the voting result storage unit 31 is configured to be able to transmit the voting result to the other wireless communication terminal 2 as well via the wireless communication unit 11, but there is no limitation to this, and it is also possible to use a configuration in which the voting result is not transmitted to another wireless communication terminal.

The voting result display unit 32 displays the addition result of the vote data stored in the voting result storage unit 31. In other words, the voting result display unit 32 displays the voting result on a display screen such as a liquid crystal screen in the case where the vote data is accumulated in the voting result storage unit 31. The voting result display unit 32 also displays the result of the determination performed by the later-described network construction determination unit 34 regarding participation in the construction of the wireless network. Note that the voting result display unit 32 may also display only one of the addition result and the determination result. Also, if it is not necessary to display the voting result and the determination result, the voting result display unit 32 need not be provided in the wireless network construction apparatus 1.

The threshold value storage unit 33 stores the threshold value of the vote data for the later-described network construction determination unit 34 to determine whether or not to participate in the construction of the wireless network. The threshold value stored in the threshold value storage unit 33 may be set by a user or the like, or may be a value set in advance.

The network construction determination unit 34 determines whether or not the addition result of the vote data stored in the voting result storage unit 31 is greater than the threshold value stored in the threshold value storage unit 33, and if the addition result of the vote data is greater than the threshold value, the network construction determination unit 34 determines to participate in the construction of the wireless network. That is, if the addition result of the vote data is greater than a threshold value, the network construction determination unit 34 determines that participation has been strongly requested by the other users, and outputs a determination signal indicating participation in the construction of the wireless network. Note that if the addition result of the vote data is less than or equal to the threshold value, the network construction determination unit 34 does not output the determination signal.

If the network construction determination unit 34 determines to participate in the construction of the wireless network, or in other words, if input of the determination signal is received from the network construction determination unit 34, the network construction unit 13 participates in the construction of the wireless network. The network construction unit 13 includes a network construction execution unit 41 and an application 42.

If the network construction determination unit 34 determines to participate in the construction of the wireless network, the network construction execution unit 41 participates in the construction of the wireless network. Specifically, upon receiving the determination signal indicating participation in the network construction from the network construction determination unit 34, the network construction execution unit 41 constructs the wireless network with the other wireless communication terminal 2 using the wireless communication unit 11. Note that the network construction execution unit 41 may be configured such that the wireless communication terminal 1 is removed from the wireless network upon the elapse of a predetermined amount of time.

The application 42 functions as a program for communication in the case where the wireless network is constructed by the network construction execution unit 41. In other words, the application 42 is an application for communication, such as e-mail, for example.

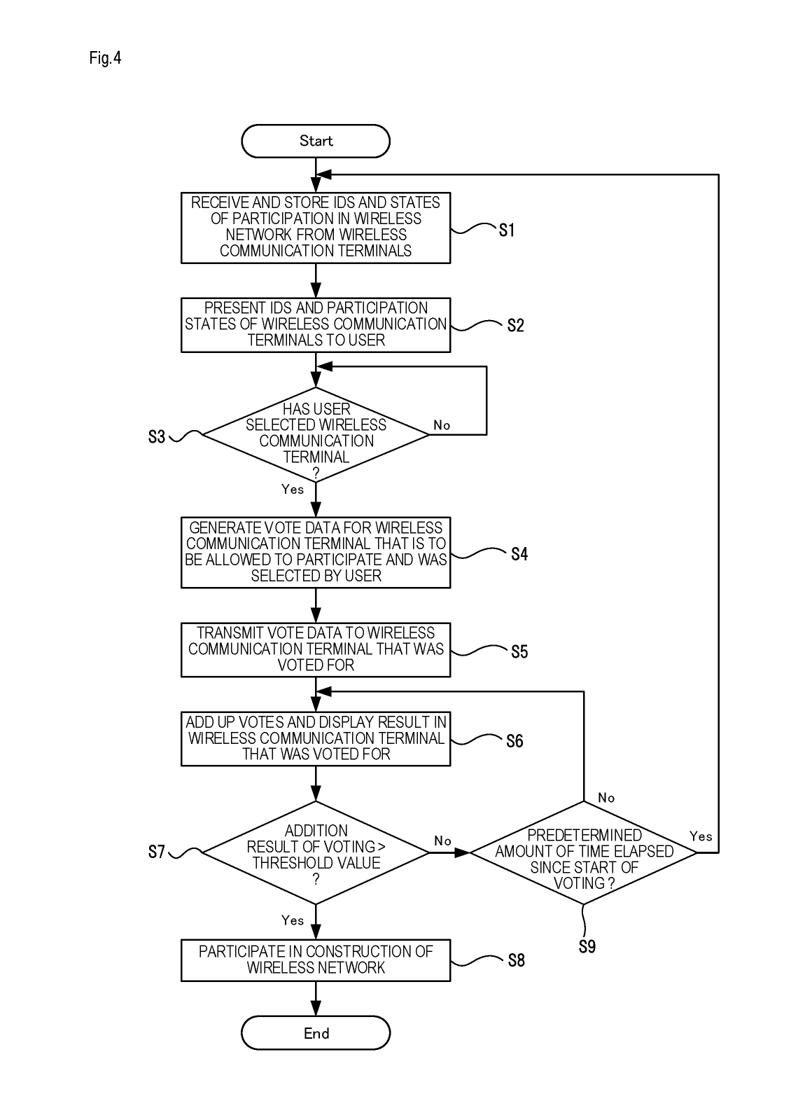

Next, operations performed by the wireless network construction apparatus I according to an embodiment of the present invention will be described with reference to FIG. 4. FIG. 4 is a flow diagram showing operations performed by the wireless network construction apparatus 1. In the following description, FIGS. 1 and 3 will be referred to as needed. Also, in the present embodiment, the wireless network construction method is carried out by causing the wireless network construction apparatus 1 to operate. Accordingly, the description of the wireless network construction method according to the present embodiment will be substituted with the description of the operations performed by the wireless network construction apparatus 1 below.

First, in the wireless network construction apparatus 1, when the Ms and the information on whether or not the other wireless communication terminals are participating in the wireless network are received from the other wireless communication terminals, these pieces of information are stored in the terminal information storage unit 21 (step S1). Note that ID-related information is stored in a storage unit (not shown) in each wireless communication terminal. In each wireless communication terminal, the information related to whether or not the other wireless communication terminals are participating in the wireless network is obtained by receiving the information on whether or not the wireless network is being constructed by the network construction execution unit 41 of the network construction unit 13 via the wireless communication unit 11.

The IDs from the other wireless communication terminals and the information on whether or not the other wireless communication terminals are participating in the wireless network may be always received, or may be received for a predetermined period after receiving a report of being in an emergency state such as an earthquake from an external device. It is also possible to use a configuration in which the user can set whether or not reception is to be performed using a dedicated application or the like.

The wireless network construction apparatus 1 displays the IDs of the other wireless communication terminals and the information on the states of participation in the wireless network, which were stored in step S1, on the display screen of the wireless communication terminal 10 using the terminal list display unit 22 (step S2). Accordingly, the user of the wireless communication terminal 10 can easily check the states of participation in the wireless network of the other wireless communication terminals.

Note that with the display screen of the wireless communication terminal 10, it is possible to select the wireless communication terminal that the user wants to allow to participate in the construction of the wireless network from among the wireless communication terminals not participating in the construction of the wireless network. In other words, in step S2, a display for voting (e.g., display of buttons for selecting a wireless communication terminal) for allowing participation of a wireless communication terminal not participating in the construction of the wireless network is also performed on the display screen of the wireless communication terminal 10.

If the user selects a wireless communication terminal that the user wants to allow to participate in the construction of the wireless network from among the other wireless communication terminals displayed on the display screen of the wireless communication terminal 10 (YES in step S3), vote data for prompting participation in the wireless network is generated for that wireless communication terminal by the voting execution unit 23 (step S4). On the other hand, if the user has not selected a wireless communication terminal that the user wants to allow to participate (NO in step S3), standby is performed until a selection is made. Note that the standby may be canceled upon the elapse of a predetermined amount of time, whereafter the flow is ended.

After the vote data is generated, the voting execution unit 23 transmits the generated vote data via the wireless communication unit 11 to the wireless communication terminal selected by the user, or in other words, to the wireless communication terminal that was voted for (step S5).

The vote data transmitted to the wireless communication terminal that was voted for is stored in the voting result storage unit 31 of the vote reception unit 14 via the wireless communication unit 11 of the wireless communication unit. With this voting result storage unit 31, the vote data is stored, and the vote data is added up and stored (step S6). Then, the addition result stored in the voting result storage unit 31 is displayed on the display screen by the voting result display unit 32, and it is transmitted as the addition result data to the other wireless communication terminal via the wireless communication unit 11 and displayed on the display screens of those wireless communication terminals (step S6).

The addition result of the vote data stored in the voting result storage unit 31 is output to the network construction determination unit 34. This network construction determination unit 34 determines whether or not the addition result of the vote data is greater than the threshold value stored in the threshold value storage unit 33 (step S7).

If the network construction determination unit 34 determines that the addition result of the vote data is greater than the threshold value (YES in step S7), the network construction execution unit 41 participates in the construction of the wireless network (step S8). The network construction execution unit 41 constructs the wireless network along with the other wireless communication terminals using the wireless communication unit 11, starts up the application 42, and uses the wireless network to perform communication through the application 42. Thereafter, the flow ends (End).

On the other hand, if the network construction determination unit 34 determines that the addition result of the vote data is less than or equal to the threshold value (NO in step S7), the processing advances to step S9, and the network construction determination unit 34 determines whether or not a predetermined amount of tune (voting period) has elapsed since the start of voting. If the predetermined amount of time has elapsed since the start of voting (YES in step S9), the processing returns to step S1, and once again, the IDs and the states of participation in the wireless network are received from the other wireless communication terminals, and if the user selects a wireless communication terminal that the user wants to participate, a vote is cast for that wireless communication terminal. Accordingly, upon the elapse of a certain period, it is possible to re-do voting according to the state of the wireless network at that time without waiting a long time for the voting result. Accordingly, voting can be performed efficiently.

If a matching amount of time has not elapsed since the start of voting (NO in step S9), the processing returns to step S6, and the addition of the votes is continued by the wireless communication terminal that was voted for. The addition of votes is continued until the addition result of the votes is greater than the threshold value in step S7, or until the predetermined amount of time has elapsed since the start of voting in step S9.

Note that the start of voting means the time at which the state of participation in the wireless network of the other wireless communication terminals is received by each wireless communication terminals.

Here, step S1 in which the IDs and information on the states of participation in the wireless network are received from the other wireless communication terminals corresponds to a participation state detection step, and steps S4 and S5 in which the vote data is transmitted to the wireless communication terminal selected by the user from among the wireless communication terminals not participating in the construction of the wireless network correspond to a voting step. Step S6 in which the wireless communication terminal that was voted for adds up the votes and transmits the result to another wireless communication terminal that displays the result on a display screen corresponds to a vote addition step, and step S7 in which it is determined whether or not the wireless communication terminal is to be allowed to participate in the construction of the wireless network based on whether or not the vote addition result is greater than a threshold value corresponds to a network construction determination step. Step S8 in which the wireless communication terminal that was voted for is allowed to participate in the construction of the wireless network according to the vote addition result corresponds to a network construction step.

According to the configuration of the present embodiment, it is possible to allow a wireless communication terminal not participating in the construction of a wireless network including multiple wireless communication terminals to participate in the construction of the wireless network according to a voting result from other communication terminals. Accordingly, a wireless network that is needed for transmission of information can be constructed without giving significant authority to a specific user. Accordingly, an efficient wireless network can be safely constructed.

A program according to an embodiment of the present invention need only be a program that causes a computer to execute steps S1 to S9 shown in FIG. 4. The wireless network construction apparatus and wireless network construction method according to the present embodiment can be realized by installing this program on a computer and executing it. In this case, the CPU (Central Processing Unit) of the computer functions and performs processing as the voting unit 12, the vote reception unit 14, and the network construction unit 13.

Also, in the present embodiment, the terminal information storage unit 21, the voting result storage unit 31, and the threshold value storage unit 33 are realized by storing a data file constituting them in a storage apparatus included in a computer, or by mounting a storage medium storing the data file in a loading apparatus connected to a computer.

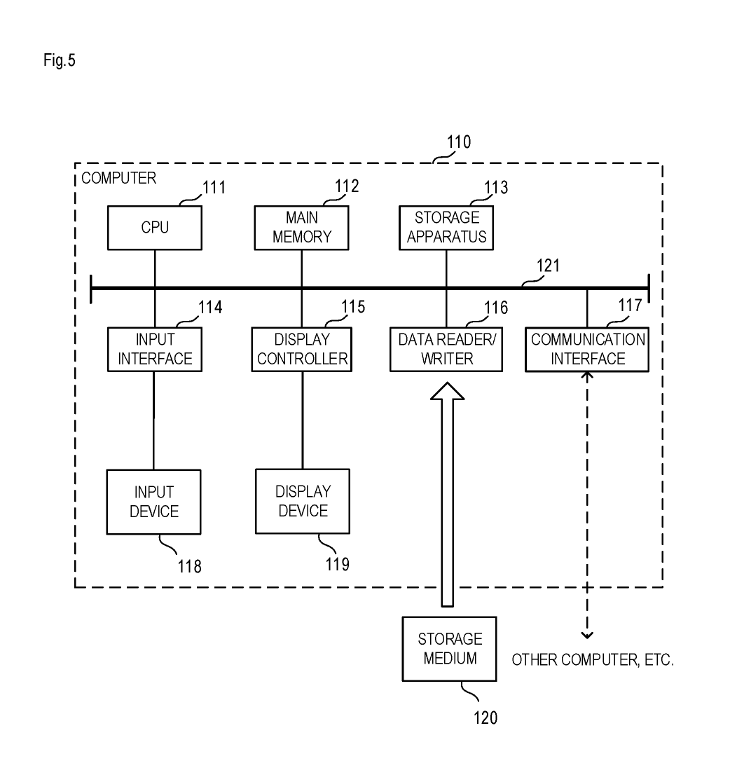

Here, a computer that realizes the wireless network construction apparatus by executing the program according to the present embodiment will be described with reference to FIG. 5. FIG. 5 is a block diagram showing an example of a computer that realizes a wireless network construction apparatus according to an embodiment of the present invention.

Note that the computer shown in FIG. 5 is not limited to being a personal computer, and encompasses mobile terminals such as tablets, smartphones, media players, and PDAs.

As shown in FIG. 5, the computer 110 includes a CPU 111, a main memory 112, a storage apparatus 113, an input interface 114, a display controller 115, a data reader/writer 116, and a communication interface 117. These units are connected via a bus 121 so as to be capable of mutual data communication.

The CPU 111 carries out various calculations by expanding programs (codes) according to the present embodiment, which are stored in the storage apparatus 113, to the main memory 112 and executing them in a predetermined sequence. The main memory 112 is typically a volatile storage device such as a DRAM (Dynamic Random Access Memory). Also, the program according to the present embodiment is provided in a state of being stored in a computer-readable storage medium 120. Note that the program according to the present embodiment may be distributed over the Internet, which is connected to via the communication interface 117.

Also, specific examples of the storage apparatus 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119 and controls display on the display device 119.

The data reader/writer 116 mediates data transmission between the CPU 111 and the storage medium 120, reads out programs from the storage medium 120, and writes results of processing performed by the computer 110 in the storage medium 120. The communication interface 117 mediates data transmission between the CPU 111 and another computer.

Also, specific examples of the storage medium 120 include a general-purpose semiconductor storage device such as CF (Compact Flash (registered trademark)) and SD (Secure Digital), a magnetic storage medium such as a flexible disk, and an optical storage medium such as a CD-ROM (Compact Disk Read Only Memory).

The above-described embodiment can be partially or entirely expressed by, but is not limited to, the following Supplementary Notes 1 to 12.

### Supplementary Note 1

A wireless network construction apparatus that is provided in a wireless communication terminal, and is for constructing a wireless network with other wireless communication terminal, including:

a wireless communication unit configured to perform wireless communication with the other wireless communication terminal;

a voting unit configured to, in a case where the wireless communication terminal is participating in construction of the wireless network, transmit vote data via the wireless communication unit to a wireless communication terminal for which participation in the construction of the wireless network is requested; and

a network construction unit configured to participate in the construction of the wireless network according to the result of voting in a case where the wireless communication terminal is a wireless communication terminal that was voted for by a said voting unit.

### Supplementary Note 2

The wireless network construction apparatus according to Supplementary Note 1, further including:

a vote addition unit configured to add up vote data transmitted from a said voting unit via the wireless communication unit; and

a network construction determination unit configured to determine whether or not to participate in the construction of the wireless network by comparing a result of the addition and a threshold value,

wherein if it is determined by the network construction determination unit to participate in the construction of the wireless network, the network construction unit participates in the construction of the wireless network.

### Supplementary Note 3

The wireless network construction apparatus according to Supplementary Note 2, further including

a voting result display unit configured to display the vote data added up by the vote addition unit,

wherein if the wireless communication terminal is a wireless communication terminal that was voted for by a said voting unit, the vote addition unit transmits the addition result to the other wireless communication terminal via the wireless communication unit, and

if the wireless communication terminal is a said other wireless communication terminals, the vote addition display unit displays the addition result when the addition result is received from the wireless communication terminal voted for by the voting unit.

### Supplementary Note 4

The wireless network construction apparatus according to Supplementary Note 1, wherein

the voting unit once again performs a voting operation after a voting period, in which a vote is received, ends.

### Supplementary Note 5

A wireless network construction method for constructing a wireless network with a plurality of wireless communication terminals, including:

a participation state detection step of detecting states of participation in the wireless network of the plurality of wireless communication terminals;

a voting step of transmitting vote data for prompting participation in the wireless network via wireless communication from a wireless communication terminal participating in the construction of the wireless network to a wireless communication terminal selected by a user of a wireless communication terminal participating in the construction of the wireless network, from among wireless communication terminals not participating in the construction of the wireless network; and

a network construction step in which the wireless communication terminal that was voted for participates in the construction of the wireless network according to the result of voting.

### Supplementary Note 6

The wireless network construction method according to Supplementary Note 5, further including:

a vote addition step of adding up vote data transmitted in the voting step in the wireless communication terminal that was voted for; and

a network construction determination step of determining whether or not to participate in the construction of the wireless network by comparing a result of the addition and a threshold value,

wherein in the network construction step, if it was determined in the network construction determination step to participate in the construction of the wireless network, the wireless communication terminal that was voted for participates in the construction of the wireless network.

### Supplementary Note 7

The wireless network construction method according to Supplementary Note 6, wherein

in the vote addition step, in the wireless communication terminal that was voted for, the addition result is transmitted to another wireless communication terminal via wireless communication, and in a said another wireless communication terminal, the addition result is displayed on a display screen when the addition result is received.

### Supplementary Note 8

The wireless network construction method according to Supplementary Note 5, wherein in the voting step, a vote is received once again after the end of a voting period in which the vote is received.

### Supplementary Note 9

A computer-readable storage medium storing a program for causing execution of a wireless network construction method for constructing a wireless network with a plurality of wireless communication terminals, the program including commands for causing a computer to execute:

a participation state detection step of detecting states of participation in the wireless network of the plurality of wireless communication terminals;

a voting step of transmitting vote data for prompting participation in the wireless network via wireless communication from a wireless communication terminal participating in the construction of the wireless network to a wireless communication terminal selected by a user of a wireless communication terminal participating in the construction of the network from among wireless communication terminals not participating in the construction of the wireless network; and

a network construction step in which the wireless communication terminal that was voted for participates in the construction of the wireless network according to the result of voting.

### Supplementary Note 10

The computer-readable storage medium according to Supplementary Note 9, wherein

the program further includes commands for causing a computer to execute:

a vote addition step of adding up vote data transmitted in the voting step in the wireless communication terminal that was voted for; and

a network construction determination step of determining whether or not to participate in the construction of the wireless network by comparing a result of the addition and a threshold value,

wherein in the network construction step, if it was determined in the network construction determination step to participate in the construction of the wireless network, the wireless communication terminal that was voted for participates in the construction of the wireless network.

### Supplementary Note 11

The computer-readable storage medium according to Supplementary Note 10, wherein

in the vote addition step, in the wireless communication terminal that was voted for, the addition result is transmitted to another wireless communication terminal via wireless communication, and in a said another wireless communication terminal, the addition result is displayed on a display screen when the addition result is received.

### Supplementary Note 12

The computer-readable storage medium according to Supplementary Note 9, wherein in the voting step, a vote is received once again after the end of a voting period in which the vote is received.

Although the present invention has been described with reference to an embodiment, the present invention is not limited to the above-described embodiment. Various modifications that a person skilled in the art can understand may be applied to the configuration and the details of the present invention within the scope of the present invention.

This application claims priority to Japanese Patent Application No. 2015-070079, filed on Mar. 30, 2015, the disclosure of which is incorporated in its entirety herein by reference.

### INDUSTRIAL APPLICABILITY

The present invention can be used in a wireless network construction apparatus for constructing a wireless network with terminals.

### DESCRIPTIONS OF REFERENCE NUMERALS

1 Wireless network construction apparatus
2 to 6, 10 Wireless communication terminal
11 Wireless communication unit
12 Voting unit
13 Network construction unit
14 Vote reception unit
21 Terminal information storage unit
22 Terminal list display unit
23 Voting execution unit
31 Voting result storage unit (voting addition unit)
32 Voting result display unit
33 Threshold value storage unit
34 Network construction determination unit
41 Network construction execution unit
32 Application

What is claimed is:

1. A wireless network construction apparatus that is provided in a wireless communication terminal, and is for constructing a wireless network with other wireless communication terminal, comprising:
a wireless communication unit configured to perform wireless communication with the other wireless communication terminals;
a voting unit configured to, in a case where the wireless communication terminal is participating in construction of the wireless network, transmit vote data via the wireless communication unit to a wireless communication terminal for which participation in the construction of the wireless network is requested; and
a network construction unit configured to participate in the construction of the wireless network according to the result of voting in a case where the wireless communication terminal is a wireless communication terminal that was voted for by a said voting unit.

2. The wireless network construction apparatus according to claim 1, further comprising:
a vote addition unit configured to add up vote data transmitted from a said voting unit via the wireless communication unit; and
a network construction determination unit configured to determine whether or not to participate in the construction of the wireless network by comparing a result of the addition and a threshold value,
wherein if it is determined by the network construction determination unit to participate in the construction of the wireless network, the network construction unit participates in the construction of the wireless network.

3. The wireless network construction apparatus according to claim 2, further comprising
a voting result display unit configured to display the vote data added up by the vote addition unit,
wherein if the wireless communication terminal is a wireless communication terminal that was voted for by a said voting unit, the vote addition unit transmits the addition result to the other wireless communication terminal via the wireless communication unit, and
if the wireless communication terminal is a said other wireless communication terminals, the vote addition display unit displays the addition result when the addition result is received from the wireless communication terminal voted for by the voting unit.

4. The wireless network construction apparatus according to claim 1, wherein
the voting unit once again performs a voting operation after a voting period, in which a vote is received, ends.

5. A wireless network construction method for constructing a wireless network with a plurality of wireless communication terminals, comprising:
a participation state detection step of detecting states of participation in the wireless network of the plurality of wireless communication terminals;
a voting step of transmitting vote data for prompting participation in the wireless network via wireless communication from a wireless communication terminal participating in the construction of the wireless network to a wireless communication terminal selected by a user of a wireless communication terminal participating in the construction of the wireless network, from among wireless communication terminals not participating in the construction of the wireless network; and
a network construction step in which the wireless communication terminal that was voted for participates in the construction of the wireless network according to the result of voting.

6. The wireless network construction method according to claim 5, further comprising:
a vote addition step of adding up vote data transmitted in the voting step in the wireless communication terminal that was voted for; and
a network construction determination step of determining whether or not to participate in the construction of the wireless network by comparing a result of the addition and a threshold value,
wherein in the network construction step, if it was determined in the network construction determination step to participate in the construction of the wireless network, the wireless communication terminal that was voted for participates in the construction of the wireless network.

7. The wireless network construction method according to claim 6, wherein
in the vote addition step, in the wireless communication terminal that was voted for, the addition result is transmitted to another wireless communication terminal via wireless communication, and in a said another wireless communication terminal, the addition result is displayed on a display screen when the addition result is received.

8. The wireless network construction method according to claim 5, wherein
in the voting step, a vote is received once again after the end of a voting period in which the vote is received.

9. A non-transitory computer-readable storage medium storing a program for causing execution of a wireless network construction method for constructing a wireless network with a plurality of wireless communication terminals, the program including commands for causing a computer to execute:
a participation state detection step of detecting states of participation in the wireless network of the plurality of wireless communication terminals;
a voting step of transmitting vote data for prompting participation in the wireless network via wireless communication from a wireless communication terminal participating in the construction of the wireless network to a wireless communication terminal selected by a user of a wireless communication terminal participating in the construction of the network from among wireless communication terminals not participating in the construction of the wireless network; and
a network construction step in which the wireless communication terminal that was voted for participates in the construction of the wireless network according to the result of voting.

10. The non-transitory computer-readable storage medium according to claim 9, wherein
the program further includes commands for causing a computer to execute:
a vote addition step of adding up vote data transmitted in the voting step in the wireless communication terminal that was voted for; and
a network construction determination step of determining whether or not to participate in the construction of the wireless network by comparing a result of the addition and a threshold value,
wherein in the network construction step, if it was determined in the network construction determination step to participate in the construction of the wireless network, the wireless communication terminal that was voted for participates in the construction of the wireless network.

11. The non-transitory computer-readable storage medium according to claim 10, wherein
in the vote addition step, in the wireless communication terminal that was voted for, the addition result is transmitted to another wireless communication terminal via wireless communication, and in a said another wireless communication terminal, the addition result is displayed on a display screen when the addition result is received.

12. The non-transitory computer-readable storage medium according to claim 9, wherein
in the voting step, a vote is received once again after the end of a voting period in which the vote is received.
